(19) United States
(12) Patent Application Publication
(10) Pub. No.: US 2006/0049760 A1
(43) Pub. Date: Mar. 9, 2006

(54) Metal halide lamp with ceramic discharge vessel

(75) Inventors: Matthias Lenz, Falkensee (DE); Dieter Trypke, Falkensee (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/209,744

(22) Filed: Aug. 24, 2005

(30) Foreign Application Priority Data
Sep. 7, 2004 (DE) 20 2004 013 922.7

(51) Int. Cl. H01J 17/18

(52) U.S. Cl. 313/624

(57) ABSTRACT

A metal halide lamp with ceramic discharge vessel (4), the discharge vessel having two ends (6) that are sealed with stoppers, and an electrically conducting lead-through (9) being guided through these stoppers (12), there being fastened on the lead-through an electrode (15) with a stem (16) that projects into the interior of the discharge vessel, lead-through and electrode together being designated as an electrode system. The lead-through being a niobium pin, and the electrode stem (16) consisting of two pins, a pin made from tungsten being arranged situated on the inside on the discharge side, and a pin made from molybdenum being arranged on the outside on the discharge side and having a length of 3 to 8 mm.

### TECHNICAL FIELD

The invention proceeds from a metal halide lamp with ceramic discharge vessel, the discharge vessel having two ends that are sealed with stoppers, and an electrically conducting lead-through being guided through these stoppers, there being fastened on the lead-through an electrode with a stem that projects into the interior of the discharge vessel, lead-through and electrode together being designated as an electrode system 1. It relates in this case, in particular, to lamps with a power of 100 to 250 W, preferably from 150 W.

### BACKGROUND ART

U.S. 2004/135511 discloses a metal halide lamp with ceramic discharge vessel in the case of which a lead-through consists of an Nb pin of large diameter, while the electrode is formed by a pin of small diameter. The pin is formed in two parts that have approximately the same diameter, a part of the pin on the discharge side being formed from W, while the part remote from the discharge consists of Mo. This part is completely surrounded by a filling filament that reduces the dead volume. It is customary here to use welding or soldering as the connecting technique for two electrode parts.

U.S. Pat. No. 6,208,070 discloses a metal halide lamp with ceramic discharge vessel in the case of which a lead-through consists of a Nb pin of large diameter, while the electrode is formed by a pin of small diameter. The pin is formed from two parts that have approximately the same diameter, both parts consisting of W.

### DISCLOSURE OF THE INVENTION

It is an object of the present invention to provide a metal halide lamp with ceramic discharge vessel, the discharge vessel having two ends that are sealed with stoppers, and an electrically conducting lead-through being guided through these stoppers, there being fastened on the lead-through an electrode with a stem that projects into the interior of the discharge vessel, lead-through and electrode together being designated as an electrode system, wherein the electrode system thereof being designed such that as few stresses as possible occur in the sealing area of the ceramic.

This object is achieved by means of the following features:

the stem comprises two components that are designed as pins of approximately the same diameter, the component situated on the inside with reference to the discharge being a pin made from tungsten, and the component situated on the outside with reference to the discharge being a pin made from molybdenum or Cermet, the pin made from Mo or Cermet being surrounded completely, and the pin made from W being surrounded partially by a filling filament made from Mo, the length LM of the pin made from molybdenum or Cermet being 3 to 8 mm, and the length LW of the section of the pin made from W introduced into the filling filament being dimensioned such that the pin made from W is held mechanically in the filling filament.

Particular advantageous refinements are to be found in the dependent claims.

What is involved in detail is a metal halide lamp with ceramic discharge vessel, the discharge vessel having two ends that are sealed with stoppers and an electrically conducting lead-through being guided through these stoppers, there being fastened on the lead-through an electrode with a stem that projects into the interior of the discharge vessel. Lead-through and electrode are designated together below as electrode system. The electrode stem comprises two components that are designed as pins of approximately the same diameter.

With reference to the discharge, the component situated in the inside is a pin made from tungsten, and the component situated on the outside is a pin made from molybdenum or Cermet, the pin made from Mo or Cermet being surrounded completely, ard the pin made from W being surrounded partially by a filling filament made from Mo, the length LM of the pin made from Mo being 3 to 8 mm, and the length LW of the section of the pin made from W introduced into the filling filament being dimensioned such that the pin made from W is held mechanically in the filling filament. This design avoids the cracks in the capillary-like stoppers that otherwise frequently occur given high wattages from 100 W, in particular from 150 W. The cause of this was problems with the different thermal coefficients of expansion of the materials of ceramic and W, which led to stresses in the sealing area during the phases of heating up and cooling down. By contrast, molybdenum or Cermet, preferably a mixture of Al₂O₃ and metal such as W or Mo as known per se, is well suited as a buffer between the two materials. However, the experiments to date with tripartite electrode systems have shown that the relationships between the dimensions of the individual components are decisive. On the one hand, a reliable connection must be produced between the Mo/Cermet pin and W pin, while on the other hand the W pin and Mo/Cermet pin must in each case be selected to be so long that the sealing area is connected reliably and satisfactorily to Mo material, without the reliable connection to the W component suffering thereby. A short Mo pin or Cermet pin that is at most 8 mm long is essential.

The stem can be connected to the lead-through via a plug-in connection or a welded connection.

Since the filling filament functions simultaneously as holder for the W pin, an adequate installed length of the W pin in the filling filament is important, but without coming too close to the high temperatures in the discharge. A reliable holder with moderate loading of the Mo pin is achieved when the ratio between the length LM and the length LW is between 0.8 and 1.2.

The invention becomes particularly effective when the power of the lamp is in the range of 100 to 400 W, in particular 150 to 250 W. Simpler alternative concepts can be used in the case of lower powers and of higher powers. Mo pins are preferably used in the range up to 150 W, but rather Cermet pins in the range thereabove.

The high reliability of this design is optimized when the fused ceramic completely shields the region of the lead-through and shields at least 80% of the length LM. This provides reliable protection against the aggressive filling contained in the discharge volume.

As is known per se, the Mo pin or Cermet pin can be fastened mechanically in a bore of the lead-through. Cermet pins as such are previously known from U.S. Pat. No. 6,181,065, for example.

The invention is further directed toward an electrode system for a metal halide lamp with ceramic discharge vessel, the electrode system comprising a lead-through and an electrode stem consisting of two components that are designed as pins of the same diameter, the component situated on the inside with reference to the discharge being a pin made from tungsten, and the component situated on the outside with reference to the discharge being a pin made from Mo or Cermet, the pin made from Mo or Cermet being surrounded completely, and the pin made from W being surrounded partially by a filling filament made from Mo, the length LM of the pin made from Mo or Cermet being 3 to 8 mm, and the length LW of the section of the pin made from W introduced into the filling filament being dimensioned such that the pin made from W is held mechanically in the filling filament.

The mechanical holder of the W pin is preferably further supported in the filling filament by crimping or clamping. Crimping is understood here as localized pressing, and clamping as comprehensive pinching of the filling filament.

What is involved, in particular, is a metal halide lamp with ceramic discharge vessel from aluminum oxide, the discharge vessel having two ends that are sealed with ceramic stoppers. An electrically conducting lead-through that with reference to the discharge can consist of an inner part and an outer pin-shaped part is led in a vacuum-tight fashion through said stops. The lead-through is a pin that is sealed at least on the outside at the stopper by means of glass solder or fuse ceramic. Fastened inside on the lead-through is an electrode with its stem that projects into the interior of the discharge vessel. The electrode can have a head that is designed as a ball, pin, form part or helix.

The stopper can be of unipartite or else multipartite design. For example, it is possible in a way known per se for a stopper capillary to be surrounded by an annular stopper part.

The lead-through or the outer part thereof is typically completely sealed in the glass solder over the length located in the stopper. It is important that the niobium pin be completely covered by glass solder because of the corrosive attack of the filling on niobium.

In a preferred embodiment, the lead-through is a niobium pin that is provided with an encircling bore, the point being that a bore can be produced easily and reliably and delivers a very effective fixing of the Mo pin that is to be joined.

### BRIEF DESCRIPTION OF THE DRAWINGS

The invention is to be explained below in more detail with the aid of a plurality of exemplary embodiments. In the drawing:

FIG. 1 shows a schematic of a metal halide lamp with ceramic discharge vessel,

FIG. 2 shows a schematic of the end region of the lamp of FIG. 1, in detail,

FIG. 3 shows a schematic of a further exemplary embodiment of an electrode system,

### BEST MODE FOR CARRYING OUT THE INVENTION

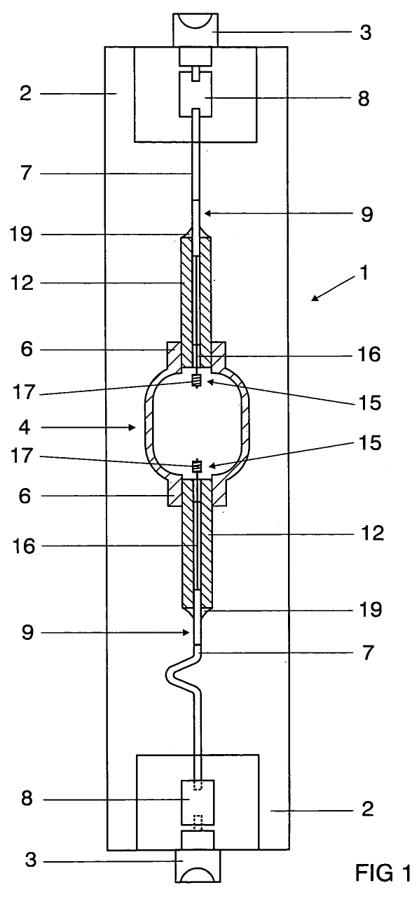

A metal halide lamp with a power of 150 W is illustrated schematically in FIG. 1. It comprises a cylindrical outer bulb 1, which is made from quartz glass, defines a lamp axis and is pinched (2) and provided with a base (3) at both ends.

Of course, the lamp can also be sealed at one end and be provided, for example, with a screw base. The axially arranged discharge vessel 4 made from Al₂O₃ ceramic is of cylindrical or convex shape and has two ends 6. It is held in the outer bulb 1 by means of two supply leads 7 that are connected to the base parts 3 via foils 8. The supply leads 7 are welded to lead-throughs 9, 10 which are fitted in each case in an end stopper at the end 6 of the discharge vessel. The end stopper part is designed as an elongated capillary tube 12 (stopper capillary). The end 6 of the discharge vessel and the stopper capillary 12 are directly sintered to one another, for example. An electrode 15 is seated on the discharge side of the lead-through.

The lead-through 9 is designed in each case as a niobium pin and projects into the capillary tube 12 up to approximately one quarter of the length thereof. Thereafter, an extended electrode stem 16 made from tungsten and having a filament 17 pushed on at the discharge-side end of the stem extends inside the capillary tube 12 to the discharge volume.

In addition to an inert ignition gas, for example argon, the filling of the discharge vessel consists of mercury and additions of metal halides. Also possible, for example, is the use of a metal halide filling without mercury, it being preferred to select xenon as ignition gas and, in particular, a higher pressure, substantially above 1.3 bars.

The niobium pin 9 is inserted into the stopper capillary 12 to a depth of approximately 3 mm and sealed by means of glass solder 19. It is important in this case that the glass solder completely covers this niobium pin and also that the start of the stem 16, for example at least 3 mm, is still covered by the glass solder.

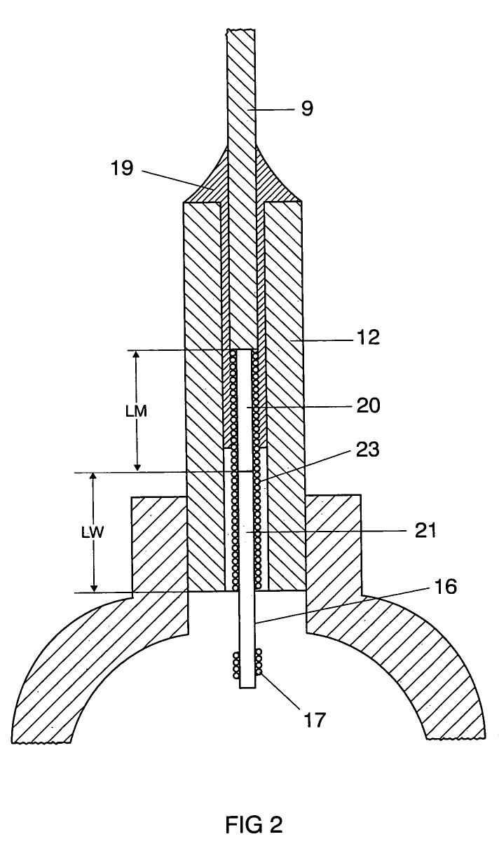

FIG. 2 shows the electrode system in the stopper in detail. A niobium pin with a diameter of 0.88 mm serves as lead-through 9. Welded to it is an Mo pin 20 with a diameter of approximately 0.5 mm. It has a length of 5 mm for a power of 150 W. It is an outer part of an electrode stem 16 that further comprises a W pin 21 of the same diameter and overall length of 10 mm. The entire Mo pin 20 and a partial length of 4.5 mm of the W pin 21 are sheathed by a filling filament 23 made from Mo. It consists of an Mo wire with a diameter of 150 μm. This wire holds the W pin 21 in a purely mechanical fashion by means of an interference fit.

The part of the stem 16 that is situated in the stopper capillary is surrounded as far as possible by the filling filament 23 made from molybdenum, in order to minimize the dead volume. The glass solder 19 extends from outside as far as approximately over the length LM of the Mo pin into the stopper capillary 12.

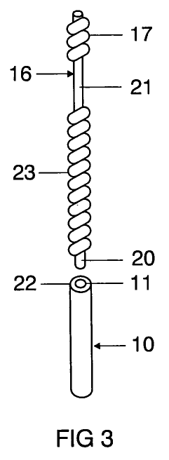

FIG. 3 shows a further exemplary embodiment of an electrode system. A niobium pin with a diameter of 0.88 mm serves as lead-through 10. It has a bore 11 of depth 2 mm and diameter 0.42 mm. This bore has an encircling wall 22. The part 20 of the stem 16 made from molybdenum is inserted into the bore and fastened there by means of crimping, as known per se. It is possible in this way to dispense with welding completely, despite the optimized selection of three different materials in the electrode system. The W pin 21 holds the helix 17.

Depending on wattage, the diameter of the Nb pin 10 and of the stem 16 can be selected differently in each case. Here, the diameter of the lead-through 10 and the diameter of the electrode stem 16 are generally virtually the same.

The diameter of the stem 16 is preferably between 3 and 10% smaller than that of the niobium pin 10, in order to provide a step on which the glass solder 19, see FIG. 2, can remain effectively bonded.

What is claimed is:

1. A metal halide lamp with ceramic discharge vessel, the discharge vessel having two ends that are sealed with stoppers, and an electrically conducting lead-through being guided through these stoppers, there being fastened on the lead-through an electrode with a stem that projects into the interior of the discharge vessel, lead-through and electrode together being designated as an electrode system, wherein the stem comprises two components that are designed as pins of approximately the same diameter, the component situated on the inside with reference to the discharge being a pin made from tungsten, and the component situated on the outside with reference to the discharge being a pin made from molybdenum or Cermet, the pin made from Mo or Cermet being surrounded completely, and the pin made from W being surrounded partially by a filling filament made from Mo, the length LM of the pin made from molybdenum or Cermet being 3 to 8 mm, and the length LW of the section of the pin made from W introduced into the filling filament being dimensioned such that the pin made from W is held mechanically in the filling filament.

2. The metal halide lamp as claimed in claim 1, wherein the ratio between the length LM and the length LW is between 0.8 and 1.2.

3. The metal halide lamp as claimed in claim 1, wherein the power of the lamp is in the range of 100 to 400 W, in particular 150 to 250 W.

4. The metal halide lamp as claimed in claim 1, wherein a fused ceramic completely shields the region of the lead-through and shields at least 80% of the length LM.

5. The metal halide lamp as claimed in claim 1, wherein the Mo pin or Cermet pin is fastened mechanically in a bore of the lead-through.

6. The metal halide lamp as claimed in claim 1, wherein the Mo pin is used for a power of at most 150 W, and the Cermet pin is used for a power of more than 150 W.

7. An electrode system for a metal halide lamp with ceramic discharge vessel, wherein the electrode system comprises a lead-through and an electrode stem consisting of two components that are designed as pins of the same diameter, the component situated on the inside with reference to the discharge being a pin made from tungsten, and the component situated on the outside with reference to the discharge being a pin made from molybdenum or Cermet, the pin made from Mo or Cermet being surrounded completely, and the pin made from W being surrounded partially by a filling filament made from Mo, the length LM of the pin made from molybdenum or Cermet being 3 to 8 mm, and the length LW of the section of the pin made from W introduced into the filling filament being dimensioned such that the pin made from W is held mechanically in the filling filament.
